(19) United States
(12) Patent Application Publication
(10) Pub. No.: US 2018/0158605 A1
(43) Pub. Date: Jun. 7, 2018

(54) SYSTEM AND METHOD FOR FORMING ADDITIVE MANUFACTURED COMPONENTS INTEGRALLY WITH PREFORMED COMPONENTS

(71) Applicant: General Electric Company, Schenectady, NY (US)

(72) Inventor: Tiffany Muller Craft, Simpsonville, SC (US)

(21) Appl. No.: 15/367,810

(22) Filed: Dec. 2, 2016

(51) Int. Cl. H01F 41/02; B33Y 10/00; B33Y 30/00; B33Y 50/02; B33Y 70/00; B22F 3/00; B33Y 80/00

(52) U.S. Cl. CPC H01F 41/0253; B33Y 10/00; B33Y 30/00; B33Y 80/00; B33Y 70/00; B22F 3/008; B33Y 50/02

(57) ABSTRACT

Additive manufacturing systems are disclosed. The systems may include a build platform for a preformed component and/or a magnetic powder material, and at least one magnet positioned adjacent the build platform. The magnet(s) may be configured to manipulate the magnetic powder material to form a pre-sintered component in contact with the preformed component. The system may also include at least one sprayer nozzle positioned adjacent the build platform. The sprayer nozzle(s) may be configured to coat the pre-sintered component formed from the magnetic powder material with a binder material. Additionally, the system may include a heated build chamber substantially surrounding the build platform. The heated build chamber may be configured to heat the pre-sintered component to form a sintered portion integral with the preformed component.

### CROSS-REFERENCE TO RELATED APPLICATION

This application is related to co-pending U.S. application Ser. No. ______, GE docket numbers 314248-1 and 314869-1, all filed on Dec. 2, 2016.

### BACKGROUND OF THE INVENTION

The disclosure relates generally to additive manufacturing, and more particularly, to additive manufacturing systems and methods of forming additive manufactured components integrally with distinct, preformed components.

Components or parts for various machines and mechanical systems may be built using additive manufacturing systems. Conventional additive manufacturing systems may build such components by continuously layering powder material in predetermined areas and performing a material transformation process on each layer of the powder material until a component is built. The material transformation process may alter the physical state of each layer of the powder material from a granular composition to a solid material. The components built using these conventional additive manufacturing systems and processes have nearly identical physical attributes as conventional components typically made by performing machining processes on stock material.

Conventional additive manufacturing systems and/or conventional additive manufacturing processes typically require a large amount of time to create a final component. For example, each component is built layer-by-layer and each layer of the powder material can have a maximum thickness in order to ensure each layer of powder material undergoes a desirable material transformation when forming the component. As such, the material layering and material transformation process may be formed numerous times during the building of the component. Furthermore, each time a single layering and material transformation process is performed, additional processes must be performed to ensure the component is being built accurately, and/or according to specification. Some of these additional processes include realigning the component and/or the build plate in which the component is being built on, adjusting devices or components used to perform the material transformation process (e.g., lasers), reapplying powder material in portions of the layer being formed that require additional material, and/or removing excess powder material from the layer being formed and/or the portions of the component already built. As a result, building a component using conventional additive manufacturing systems and/or processes can take hours or even days.

Additionally, with respect to conventional additive manufacturing systems and/or processes, there are no known systems and/or processes for forming a portion of a component using additive manufacturing directly on or integral with another portion of the component previously formed using other processes (e.g., machining). That is, a first portion of a component formed by conventional processes (e.g., machining) and a second portion of the component formed using conventional additive manufacturing systems and/or processes must be built separately, and must undergo additional processes (e.g., polishing, grinding, welding, brazing and the like) to join the portions to form the component. This process adds additional time, processes, materials and/or cost to manufacturing components. Furthermore, because the portions of the component are manufactured separately and subsequently joined, the risk of portions of the component becoming detached or separated increases over the operational life of the component.

### BRIEF DESCRIPTION OF THE INVENTION

A first aspect of the disclosure provides an additive manufacturing system including: a build platform configured to receive: a preformed component; and a magnetic powder material; at least one magnet positioned adjacent the build platform, the at least one magnet configured to manipulate the magnetic powder material to form a pre-sintered component in contact with the preformed component; at least one sprayer nozzle positioned adjacent the build platform, the at least one sprayer nozzle configured to coat the pre-sintered component formed from the magnetic powder material with a binder material; and a heated build chamber substantially surrounding the build platform, the heated build chamber configured to heat the pre-sintered component to form a sintered portion integral with the preformed component.

A second aspect of the disclosure provides a method of forming a unibody component. The method includes: manipulating a magnetic powder material, using magnetic waves, to form a pre-sintered component having a first geometry, the magnetic powder material positioned adjacent a build platform; covering the pre-sintered component formed from the magnetic powder material with a binder material; and sintering the pre-sintered component formed from the magnetic powder material to form a sintered portion integral with a preformed component, the sintered portion having a second geometry identical to the first geometry of the pre-sintered component.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a front view of an additive manufacturing system including a plurality of magnets, magnetic powder material and a preformed component according to embodiments.

FIG. 2 shows a top view of the additive manufacturing system, the magnetic powder material and the preformed component of FIG. 1, according to embodiments.

FIG. 3 shows a front view of the additive manufacturing system of FIG. 1, a pre-sintered component formed from the magnetic powder material and the preformed component of FIG. 1 according to embodiments.

FIG. 4 shows a top view of the additive manufacturing system, the pre-sintered component formed from the magnetic powder material and the preformed component of FIG. 3, according to embodiments.

FIG. 5 shows a front view of the additive manufacturing system of FIG. 3, and a binder material covering the pre-sintered component formed from the magnetic powder material of FIG. 3 according to embodiments.

FIG. 6 shows a front view of the additive manufacturing system of FIG. 5, and the binder material covering the pre-sintered component formed from the magnetic powder material of FIG. 3 according to embodiments.

FIG. 7 shows a front view of the additive manufacturing system of FIG. 6 heating the pre-sintered component formed from the magnetic powder material covered in the binder material according to embodiments.

FIG. 8 shows a front view of the additive manufacturing system of FIG. 7 and a unibody component formed from the magnetic powder material integrally formed with the preformed component according to embodiments.

FIG. 9 shows a front view of an additive manufacturing system and a unibody component formed from the magnetic powder material sintered to the preformed component according to embodiments.

FIG. 10 shows a front view of an additive manufacturing system including two distinct pre-sintered components formed from magnetic powder material according to further embodiments.

FIG. 11 shows a front view of an additive manufacturing system and a preformed component positioned on a pre-sintered component formed from magnetic powder material according to embodiments.

FIG. 12 shows a front view of an additive manufacturing system and a pre-sintered component formed from magnetic powder material positioned adjacent a preformed component according to embodiments.

FIG. 13 shows a flow chart of an example process for forming a unibody component from a sintered portion and a preformed component, according to embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within an additive manufacturing system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure provides additive manufacturing, and more particular, the disclosure provides additive manufacturing system and methods of forming additive manufactured components integrally with distinct, preformed components.

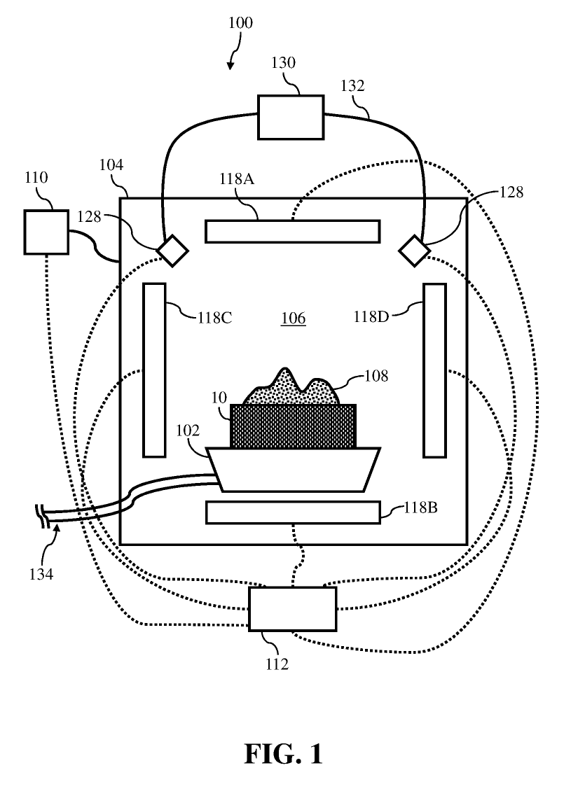

These and other embodiments are discussed below with reference to FIGS. 1-13. However, those skilled in the art will readily appreciate that the detailed description given herein with respect to these Figures is for explanatory purposes only and should not be construed as limiting.

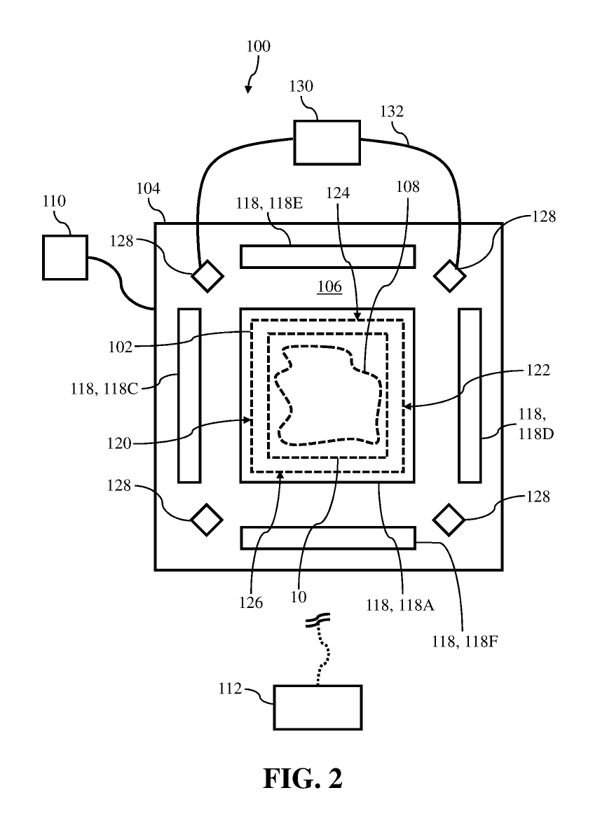

FIGS. 1 and 2 show a front and top view, respectively, of an additive manufacturing system 100. As discussed herein, additive manufacturing system 100 may utilize magnetic waves to initially manipulate powder material to form an entire component and subsequently sinter the entire component using a heat source. Additive manufacturing system 100 and the process of forming a unibody component using additive manufacturing system 100, as discussed herein, may significantly reduce a time required to build a component from powder material.

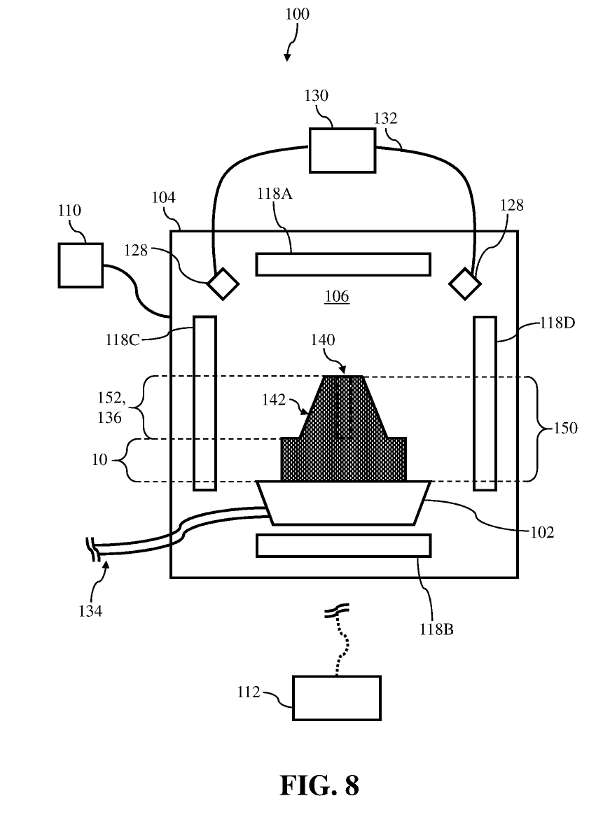

As shown in FIGS. 1 and 2, additive manufacturing system 100 (hereafter, “AMS 100”) may include a build platform 102. Build platform 102 may be positioned within a heated build chamber 104 of AMS 100. That is, build platform 102 may be positioned or disposed within a chamber or cavity 106 of heated build chamber 104, such that heated build chamber 104 may substantially surround build platform 102. Build platform 102 may include a build plate (not shown), a build surface and/or build structure for a preformed component 10 and/or a magnetic powder material 108 that may be utilized by AMS 100 to form a unibody component. As shown in FIGS. 1 and 2 preformed component 10 and magnetic powder material 108 may be positioned within heated build chamber 104, and more specifically, may be positioned on and/or adjacent build platform 102 of AMS 100. As discussed in detail herein, build platform 102 may receive preformed component 10 and magnetic powder material 108 and may provide a build structure for the unibody component (see, FIG. 8) formed from preformed component 10 and magnetic powder material 108 using AMS 100.

Build platform 102 may be formed from any suitable material that may receive and/or support preformed component 10, magnetic powder material 108 and the unibody component formed from preformed component 10 and magnetic powder material 108, as discussed herein. In non-limiting examples, build platform 102 may be formed from non-magnetic, diamagnetic or paramagnetic materials to prevent or significantly reduce any magnetic attraction between build platform 102 and magnetic powder material 108 and/or any other component of AMS 100. In another non-limiting example, build platform 102 may be formed from a magnetic material (e.g., ferromagnetic material) to improve and/or influence a magnetic attraction between build platform 102 and magnetic powder material 108 and/or any other component of AMS 100. Additionally, the size and/or geometry of build platform 102 of AMS 100 may be dependent on, at least in part, the amount of magnetic powder material 108 utilized by AMS 100 to form the unibody component, the size of the unibody component and/or the geometry of the unibody component formed by AMS 100.

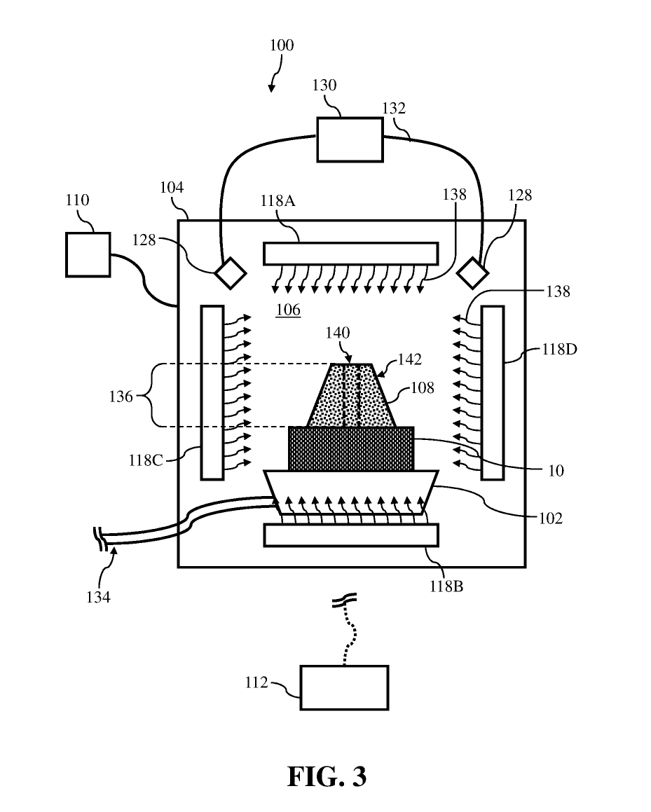

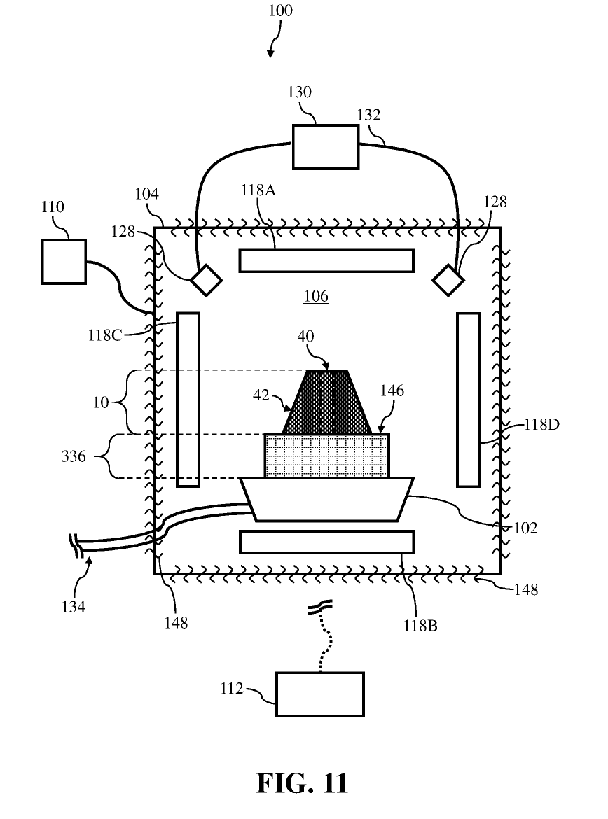

Preformed component 10 may be positioned within heated build chamber 104, adjacent build platform 102. Specifically, and as shown in FIGS. 1 and 2, preformed component 10 may be received by and/or may be positioned directly on build platform 102 of AMS 100. In the non-limiting example, and as discussed herein, preformed component 10 may be positioned directly on build platform 102, and magnetic powder material 108 may subsequently positioned on preformed component 10. In other non-limiting examples discussed herein, performed component 10 may be positioned adjacent build platform 102 and on a pre-sintered component (see, FIG. 3) formed from magnetic powder material 108 (see, FIG. 11). Preformed component 10 positioned on build platform 102 may be held in place by the weight of preformed component 10. Alternatively, AMS 100 may include additional components (e.g., straps, restraints and so on) (not shown) that may be utilized and/or may contact preformed component 10 to couple and/or hold preformed component 10 on build platform 102.

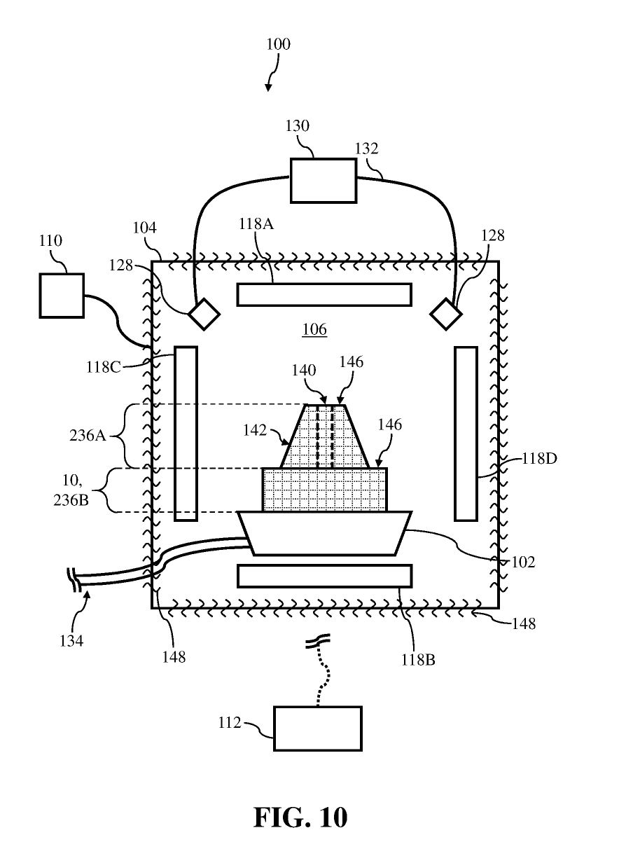

In the non-limiting example shown in FIGS. 1 and 2, preformed component 10 may be formed as a substantially finished component or portion of the unibody component (see, FIG. 8) to be formed by AMS 100. That is, preformed component 10 may include all of the desired features and/or geometries to be included in the portion of the unibody component formed by preformed component 10 using AMS 100. Preformed component 10 may be formed prior to being placed and/or positioned within heated build chamber 104 and may be formed using any suitable formation process including, but not limited to, machining, tooling, grinding, drilling, planning, polishing, etching and the like. Additionally, preformed component 10 may be formed from any suitable material that withstand and/or not be deformed when exposed to heat generated by heated build chamber 104 when sintering magnetic powder material 108, as discussed herein. In a non-limiting example, preformed component 10 may be formed from various metal-alloys that are capable of being welded upon including, but not limited to, various stainless steels, nickel-based alloys, cobalt alloys, hastalloys, Haynes materials and the like. In other non-limiting examples discussed herein (see, FIG. 10), preformed component 10 may be formed from a distinct pre-sintered component that may also be formed from magnetic powder material 108, and may be formed by additive manufacturing processes (e.g., material manipulating, sintering).

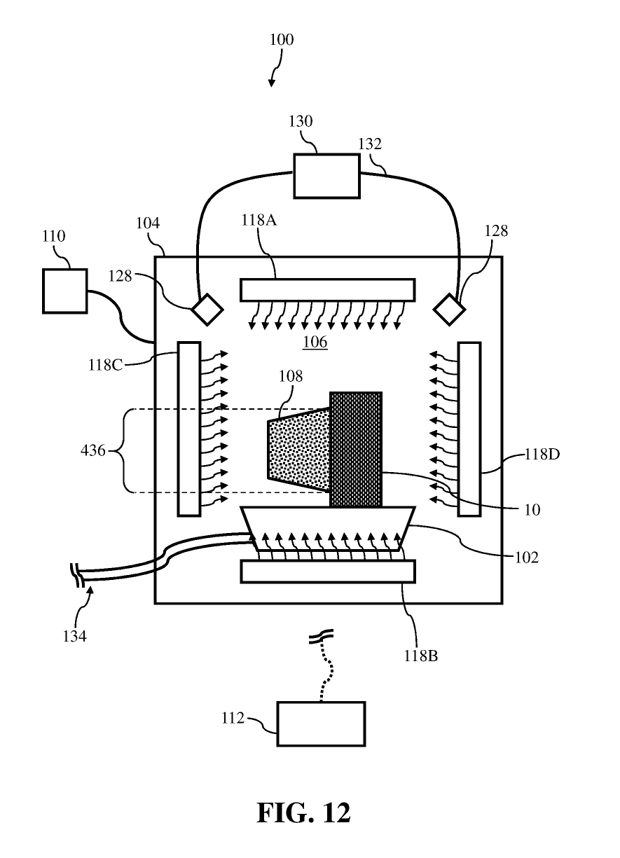

As shown in FIGS. 1 and 2, and discussed herein, magnetic powder material 108 may be positioned within heated build chamber 104 and/or may be positioned adjacent build platform 102. Specifically in the non-limiting example depicted in FIGS. 1 and 2, magnetic powder material 108 may be positioned directly on a portion of preformed component 10, and may be positioned above, opposite and/or adjacent build platform 102. As discussed herein, magnetic powder material 108 may be positioned directly on preformed component 10 to be sintered and form a unibody (see, FIG. 8) component with preformed component 10. In other non-limiting examples discussed herein, magnetic powder material 108 may be formed directly on build platform 102. In these non-limiting examples discussed herein, preformed component 10 may be positioned either directly on magnetic powder material 108 (see, FIG. 11), or alternatively, preformed component 10 may be positioned adjacent magnetic powder material 108 and positioned directly on build platform 102 as well (see, FIG. 12).

Magnetic powder material 108 utilized by AMS 100 may include a variety of powder materials that may include magnetic properties and/or a magnetic moment. Specifically, magnetic powder material 108 may be formed from a magnetic material that may be influenced, displaced, manipulated and/or altered by magnetic waves or energy. In non-limiting examples, magnetic powder material 108 may be formed from ferromagnetic materials including, but not limited to, iron, cobalt, nickel, metal alloys and any other suitable ferrous/magnetic material that is capable of being welded. Additionally, magnetic powder material 108 may be formed from a material that is capable of being sintered when heated. It is understood that “magnetic powder material 108” and “powder material 108” may be used interchangeably, and may refer to any powder material that includes similar material characteristics or properties, and may undergo the processes discussed herein.

As shown in FIGS. 1 and 2, heated build chamber 104 may at least partially and/or substantially surround build platform 102 and magnetic powder material 108. Specifically in non-limiting examples, heated build chamber 104 may completely surround and/or encapsulate build platform 102, or alternatively, heated build chamber 104 may only partially surround build platform 102. Heated build chamber 104 may be formed as any suitable structure and/or enclosure including build cavity 106 that may receive build platform 102, magnetic powder material 108 and/or additional components of AMS 100 that may be utilized to form a sintered component. As discussed herein, heated build chamber 104 may be heated and/or may provide heat (as a heat source) to cavity 106 including magnetic powder material 108 to form the sintered component from magnetic powder material 108. In a non-limiting example shown in FIGS. 1 and 2, heated build chamber 104 may be configured as a heat source, and may be coupled to and/or in communication with a heating component 110 that may provide energy (e.g., electricity) to heated build chamber 104 to heat cavity 106. In another non-limiting example, and discussed herein, cavity 106 and/or heated build chamber 104 may be heated and/or provided heat by placing heated build chamber 104, including all components of AMS 100 positioned within heated build chamber 104, into or adjacent a larger heating source or component.

Heated build chamber 104 may be formed from any suitable material that may be capable of withstanding high temperature (e.g., 2000° C.) and/or heating to form the unibody component from preformed component 10 and magnetic powder material 108, as discussed herein. In a non-limiting example, heated build chamber 104 may be formed from an ultra-high-temperature ceramic material. Similar to build platform 102, heated build chamber 104 may also be formed from a material having magnetic properties to improve, or alternatively, non-magnetic properties to reduce magnetic attraction between heated build chamber 104 and magnetic powder material 108. Additionally, the size and/or geometry of heated build chamber 104 may be dependent on, at least in part, the size and/or the geometry of the unibody component formed by AMS 100.

As shown in FIGS. 1 and 2, a controller 112 of AMS 100 may be in electrical communication with heat source 110 in electrical communication with heated build chamber 104. Controller 112 may be any suitable electronic device or combination of electronic devices (e.g., computer system, computer program product, processor and the like) that may be in electrical communication with heat source 110 and may be configured to adjust the operation of heat source 110. That is, controller 112 may be in electrical communication with heat source 110 and during a process of forming a unibody component using AMS 100, as discussed herein, controller 112 may be configured to activate and/or engage heat source 110 to provide energy (e.g., electricity) to heated build chamber 104 to heat cavity 106.

AMS 100 may also include at least one magnet 118 positioned adjacent build platform 102. As shown in the non-limiting example of FIGS. 1 and 2, AMS 100 may include a plurality of magnets 118 that may be positioned adjacent to and/or substantially surround build platform 102. The plurality of magnets 118 may be positioned within heated build chamber 104, and more specifically, within cavity 106 of heated build chamber 104. In another non-limiting example, not shown, the plurality of magnets 118 of AMS 100 may be positioned outside of and substantially adjacent to heated build chamber 104. As shown in FIGS. 1 and 2, the plurality of magnets 118 may also substantially surround build platform 102 preformed component 10 and/or magnetic powder material 108, respectively. As discussed herein, the positioning and/or alignment of each of the plurality of magnets 118 of AMS 100 may aid in the formation of a pre-sintered component (see, FIG. 3) from magnetic powder material 108. That is, and as discussed in detail herein, each of the plurality of magnets 118 positioned within heated build chamber 104 may be configured to produce magnetic waves or fields to manipulate magnetic powder material 108 to form a pre-sintered component within heated build chamber 104 that may be heated to form a unibody component (see, FIG. 8).

As shown in FIGS. 1 and 2, and discussed herein, the plurality of magnets 118 may substantially surround build platform 102. Specifically, AMS 100 may include a first magnet 118A positioned above build platform 102, and a second magnet 118B (see, FIG. 1) positioned below build platform 102. As shown in FIG. 1, second magnet 118B may be positioned opposite and/or may be substantially aligned (e.g., vertically) with first magnet 118A. In the non-limiting example shown, second magnet 118B may be positioned below build platform 102.

The plurality of magnets 118 of AMS 100 may also include magnets 118C, 118D, 118E (see, FIG. 2), 118F (see, FIG. 2) that are positioned substantial adjacent to, in line with and/or surround build platform 102, preformed component 10 and magnetic powder material 108, respectively. With reference to FIG. 2, magnets 118C, 118D, 118E, 118F may be positioned on distinct sides of build platform 102, preformed component 10 and magnetic powder material 108, respectively. Specifically, third magnet 118C may be positioned adjacent a first side 120 (see, FIG. 2) of build platform 102, and fourth magnet 118D may be positioned on a second side 122 (see, FIG. 2) of build platform 102, opposite first side 120 and/or third magnet 118C. Additionally, and as shown in FIG. 2, fifth magnet 118E may be positioned adjacent a third side 124 of build platform 102, and sixth magnet 118F may be positioned on a fourth side 126 of build platform 102, opposite third side 124 and/or fifth magnet 118E. Similar to first magnet 118A and second magnet 118B, the respective magnets 118C, 118D, 118E, 118F positioned substantial adjacent to and/or surrounding build platform 102 may be positioned opposite to and/or may be substantially aligned with a corresponding magnet of the plurality of magnets 118. That is, third magnet 118C may be positioned opposite and/or may be substantially aligned (e.g., horizontally and vertically) with fourth magnet 118D, and fifth magnet 118E may be positioned opposite and/or may be substantially aligned (e.g., horizontally and vertically) with sixth magnet 118F.

It is understood that the number of magnets 118 of AMS 100 shown in the figures is merely illustrative. As such, AMS 100 may include more or less magnets 118 than the number depicted and discussed herein. Additionally, the position and/or alignment of the plurality of magnets 118 within heated build chamber 104 shown in the figures is merely illustrative. The plurality of magnets 118 may be positioned or located in various locations of heated build chamber 104. Furthermore, the position/location and/or the alignment relation of each magnet 118 may be dependent on, at least in part, the number of magnets 118 included in AMS 10, the size and/or geometry of heated build chamber 104, and/or the size and/or geometry of the unibody component to be formed using AMS 100.

Each of the plurality of magnets 118 of AMS 100 may include a single magnet configured to generate magnetic waves and/or magnetic fields. That is, each of the plurality of magnets 118 of AMS 100 may be formed from a single magnet or magnetized component that may be capable of generating a magnetic wave or field. In other non-limiting examples (not shown), each magnet may be formed from a magnet array and/or a plurality of magnets or magnetized components. As shown in FIGS. 1 and 2, controller 112 of AMS 100 may also be in electrical communication with each of the plurality of magnets 118. Controller 112 may be configured to adjust operational characteristics of each of the plurality of magnets 118. That is, and as discussed herein, controller 112 may adjust operational characteristics of each of the plurality of magnets 118, and more specifically, operational characteristics of the magnets or magnetized components forming each of the plurality of magnets 118. The operational characteristics of magnets 118 adjusted by controller 112 may include, but are not limited to, a magnetic polarity for each of the plurality of magnets 118, a magnetic field strength for each of the plurality of magnets 118, an activation (e.g., on or off) of each of the plurality of magnets 118, and/or a distance between the magnets 118 and magnetic powder material 108. As discussed herein, the operational characteristics of the magnetic waves or fields generated by the magnets or magnetized components of each of the plurality of magnets 118, as well as the positioning/alignment of magnets 118, may cause the magnetic waves or fields to interact, collide and/or repel each other to manipulate magnetic powder material 108 to form a pre-sintered component within AMS 100 (see. FIG. 3).

AMS 100 may also include at least one spray nozzle 128. As shown in FIGS. 1 and 2, AMS 100 may include a plurality of spray nozzles 128 positioned within heated build chamber 104. Specifically, the plurality of spray nozzles 128 may be positioned within heated build chamber 104, adjacent to and/or substantially surrounding magnet 118A. Additionally, the plurality of spray nozzles 128 may be positioned adjacent to, substantially above and/or may substantially surround build platform 102, preformed component 10 and/or magnetic powder material 108. In non-limiting examples, spray nozzles 128 of AMS 100 may be fixed within heated build chamber 104, or alternatively, may be positioned on a track or moveable armature and may be configured to move within heated build chamber 104. In another non-limiting example, spray nozzles 128 may be positioned partially through a sidewall and/or may be formed integral with heated build chamber 104, such that only a portion of spray nozzles 128 extends into and/or is in fluid communication with cavity 106 of heated build chamber 104.

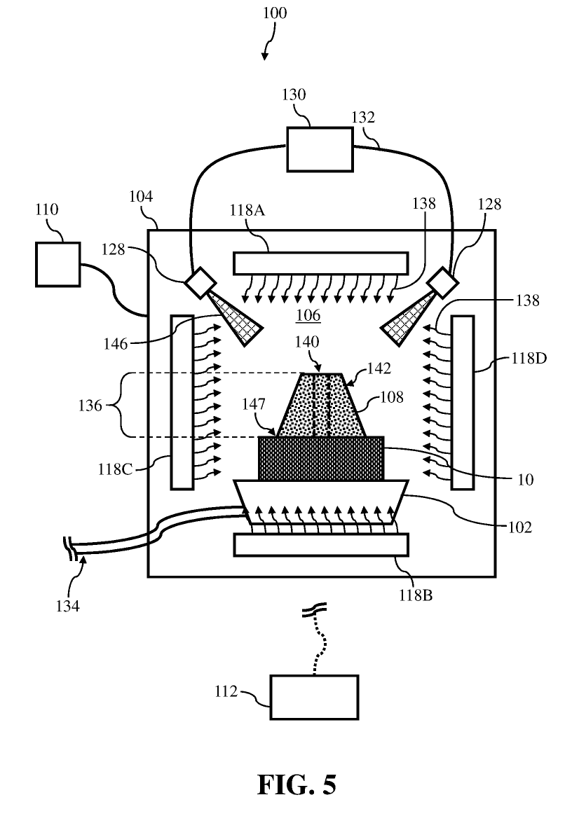

As discussed herein, spray nozzles 128 may be configured to coat a pre-sintered component made from magnetic powder material 108 with a binder material (see, FIG. 5) to maintain a geometry of the pre-sintered component during a sintering process. The binder material may be stored within a supply tank 130 of AMS 100. Supply tank 130 may be in fluid communication and/or fluidly coupled to spray nozzles 128 via conduits 132 to provide the binder material to spray nozzles 132 during the unibody component formation process discussed herein. As shown in FIGS. 1 and 2, controller 112 may be in electrical communication with each spray nozzle 128. Controller 112 may be configured to activate and/or engage spray nozzles 128 to spray and/or coat the pre-sintered component formed within heated build chamber 104 from magnetic powder material 108, as discussed herein.

It is understood that the number of spray nozzles 128 of AMS 100 shown in the figures is merely illustrative. As such, AMS 100 may include more or less spray nozzles 128 than the number depicted and discussed herein. Additionally, the position of spray nozzles 128 within heated build chamber 104 shown in the figures is merely illustrative. Spray nozzles 128 may be positioned or located in various locations of heated build chamber 104. Furthermore, the position and/or location each spray nozzle 128 may be dependent on, at least in part, the number of spray nozzles 128 included in AMS 10, the size and/or geometry of heated build chamber 104, the size and/or geometry of the unibody component to be formed using AMS 100, the composition of the binder material sprayed by spray nozzles 128 to coat the pre-sintered component and/or the ability for spray nozzles 128 to move within heated build chamber 104.

As shown in FIG. 1, AMS 100 may also include a material removal feature 134. Material removal feature 134 may be positioned within heated build chamber 104. Specifically, material removal feature 134 may be positioned within heated build chamber 104 and/or may be in (fluid) communication with cavity 106 of heated build chamber 104. Material removal feature 134 may be formed as any suitable component and/or device that may be configured to remove a non-manipulated portion of magnetic powder material 108 from heated build chamber 104. In a non-limiting example shown in FIG. 1, material removal feature 134 may be configured as a vacuum or a vacuum hose positioned on build platform 102 that may remove magnetic powder material 108 from build platform 102 and ultimately heated build chamber 104, as discussed herein. The non-manipulated portion of magnetic powder material 108 may be removed from heated build chamber 104 to prevent damage to the unibody component (see, FIG. 8) and/or prevent undesirable geometries or features from being formed on the unibody component during the formation process discussed herein.

A process for forming a unibody component form magnetic powder material 108 using AMS 100 may now be discussed with reference to FIGS. 3-8. It is understood that similarly numbered and/or named components may function in a substantially similar fashion. Redundant explanation of these components has been omitted for clarity. Additionally, controller 112 may not be shown to be in electrical communication with every magnet 118, spray nozzles 128 and/or heat source 110 as previously depicted. The communication lines from controller 112 to these various components of AMS 100 may be omitted in FIGS. 3-8 for clarity. As such, it is understood that controller 112 of AMS 100 may still be in electrical communication with magnets 118, spray nozzles 128 and/or heat source 110 as previously discussed and depicted herein with respect to FIGS. 1 and 2.

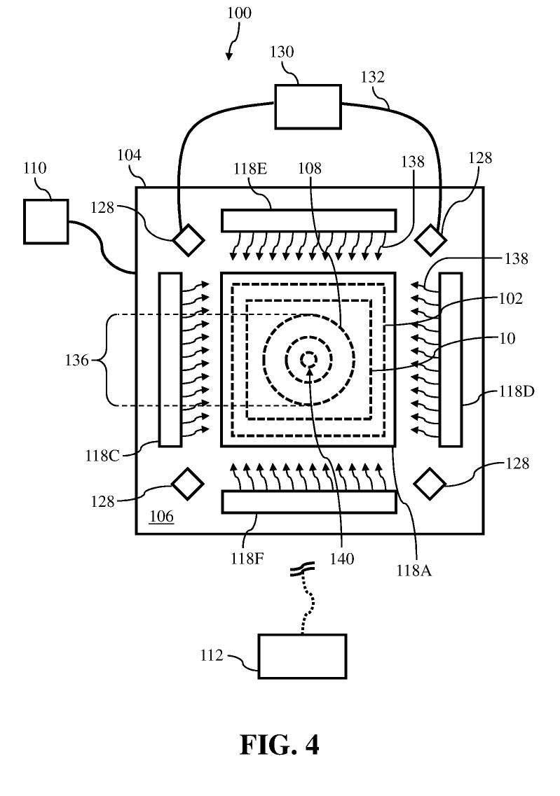

FIGS. 3 and 4 show a front and top view, respectively, of AMS 100 including preformed component 10 and magnetic powder material 108. FIGS. 3 and 4 depict a shaping, forming and/or manipulating process performed on magnetic powder material 108. That is, as shown in FIGS. 3 and 4, and distinct from FIGS. 1 and 2, AMS 100 may manipulate magnetic powder material 108 positioned directly on preformed component 10, and/or adjacent build platform 102, to form a pre-sintered component 136. Specifically, magnetic powder material 108 may be manipulated to form pre-sintered component 136 using controller 112 and the plurality of magnets 118. In the non-limiting example, pre-sintered component 136 formed from manipulated magnetic powder material 108 may be manipulated to be formed in contact with, and more specifically, directly on preformed component 10 which may be positioned directly on build platform 102. As shown in FIGS. 3 and 4, and discussed herein, the magnet or magnetized component forming each of the plurality of magnets 118 may generate and/or produce a magnetic wave or field 138, and may direct the magnetic field 138 toward build platform 102 to manipulate magnetic powder material 108. Controller 112 may adjust the operational characteristics of the plurality of magnets 118 to manipulate magnetic powder material 108 and form pre-sintered component 136 from the same. Adjusting the operational characteristics of the plurality of magnets 118 (see, FIGS. 1 and 2) may include activating at least a portion of the plurality of magnets 118, modifying a magnetic polarity for magnetic field 138 produced by each of the activated magnets or magnetized components of the plurality of magnets 118, and/or modifying the magnetic field strength of magnet field 138 generated by each of the activated magnets or magnetized components of the plurality of magnets 118.

Magnetic field 138 generated by each magnet or magnetized component of the plurality of magnets 118, and the adjustment to the operational characteristics of the magnet or magnetized components by controller 112, may form pre-sintered component 136. Specifically, magnetic field 138 directed toward magnetic powder material 108, and the adjusted operational characteristics for magnetic field 138, may manipulate at least a portion of magnetic powder material 108 to form pre-sintered component 136, having a geometry, on preformed component 10 positioned on build platform 102 and/or within heated build chamber 104. The geometry of pre-sintered component 136 may be unique and/or include distinct features for the component. In a non-limiting example shown in FIGS. 3 and 4, pre-sintered component 136 may include features such as an aperture 140 formed through pre-sintered component 136, and substantially sloping or angular sidewalls 142 (see, FIG. 3). As discussed herein, the geometry and/or the features included within pre-sintered component 136 may be substantially identical to a geometry and/or features included on a unibody component (see, FIG. 8).

To form the geometry and/or features within pre-sintered component 136, magnetic fields 138 generated by each of the plurality of magnets 118 may interact, collide and/or repel each other to manipulate magnetic powder material 108. Additionally, the operational characteristics of each magnetic field 138 generated by the plurality of magnets 118 may influence and/or alter how each magnetic field 138 of each magnet 118 interacts with distinct magnet field 138 from another magnet 118, which may in turn aid in the manipulation of magnetic powder material 108. In a non-limiting example, aperture 140 of pre-sintered component 136 may be formed using first magnet 118A and second magnet 118B. In the non-limiting example, a portion of the magnets or magnetized components in each of first magnet 118A and second magnet 118B may generate magnetic fields 138 that repel each other and/or repel magnetic powder material 108 to form aperture 140 in pre-sintered component 136.

In another non-limiting example, the operational characteristics for the plurality of magnets 118, and specifically magnets 118C, 118D, 118E, 118F, may be adjusted by controller 112 to formed angular sidewalls 142. Specifically, controller 112 may adjust the magnetic field strength for each magnet 118C, 118D, 118E, 118F such that the magnetic field strength for each magnet 118C, 118D, 118E, 118F may vary (e.g., increase or decrease) based on the proximity of the magnetized component to first magnet 118A, second magnet 118B, and/or build platform 102. Additionally in other non-limiting examples, the interaction of the magnetic fields generated by the plurality of magnets 118 may be manipulated to create “magnetic dead zones” and/or voids or areas of no magnetic attraction for magnetic powder material 108. As such, no magnetic powder material 108 may be formed or positioned within these magnetic dead zones, which may result in voids, apertures, internal spaces and/or passages within pre-sintered component 136.

It is understood that the geometry and/or features for pre-sintered component 136 depicted in FIGS. 3 and 4 are merely illustrative. As such, pre-sintered component 136 may include a variety of features that are unique and/or crucial to the component being formed by AMS 100. These variety of features may be formed by adjusting any or all of the operational characteristics of the plurality of magnets 118, as discussed herein.

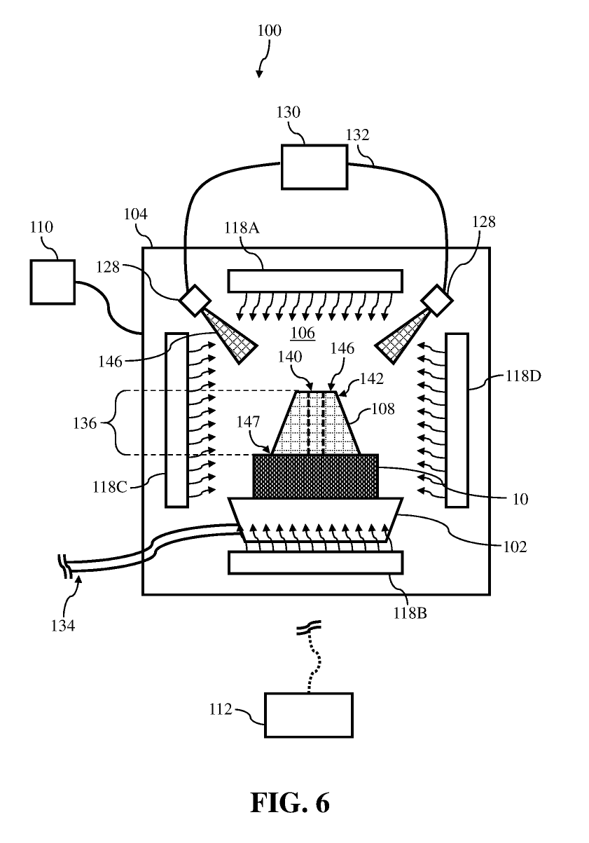

FIGS. 5 and 6 depict pre-sintered component 136 undergoing a spraying, covering or coating process. Specifically, after the manipulation of magnetic powder material 108 to form pre-sintered component 136 on preformed component 10, spray nozzles 128 of AMS 100 may spray, cover or coat pre-sintered component 136 with a binder material 146 stored and/or supplied by supply tank 130. As discussed herein, controller 112 may be in electrical communication with and may activate spray nozzles 128 to spray, cover or coat pre-sintered component with binder material 146 (see, FIG. 6). In a non-limiting example, spray nozzles 128 of AMS 100 may cover or coat pre-sintered component 136 by spraying a liquid binder material 146 directly on pre-sintered component 136 formed from magnetic powder material 108. Spray nozzles 128 may spray binder material 146 directly on pre-sintered component 136 to ensure all portions, geometries and/or features (e.g., aperture 140, angular sidewalls 142) of pre-sintered component 136 are coated with binder material 146. Additionally, spray nozzles 128 may spray binder material 146 directly on an interface 147 formed between pre-sintered component 136 formed from magnetic powder material 108 and preformed component 10. Spraying, covering or coating interface 147 with binder material 146 may ensure the portion of pre-sintered component 136 positioned directly adjacent preformed component 10 may maintain its shape and/or geometry, which may in turn ensure that pre-sintered component 136 is sintered to and/or joined to preformed component 10, as discussed herein. Additionally as discussed herein, spray nozzles 128 may be configured to move within heated build chamber 104 during the covering or coating process to ensure a desired or complete coverage of pre-sintered component 136 with binder material 146.

Binder material 146 covering or coating pre-sintered component 136 may be any suitable binder, adhesive and/or curable material that may maintain the geometry of pre-sintered component 136 after covering or coating magnetic powder material 108 forming pre-sintered component 136. As discussed herein, spraying, covering or coating pre-sintered component 136 with binder material 146 may ensure magnetic powder material 108 maintains its shape or geometry even after pre-sintered component 146 is heated beyond a Curie temperature or Curie point for magnetic powder material 108 (e.g., temperature that magnetic powder material 108 loses its permanent magnetic properties) during a heating or sintering process.

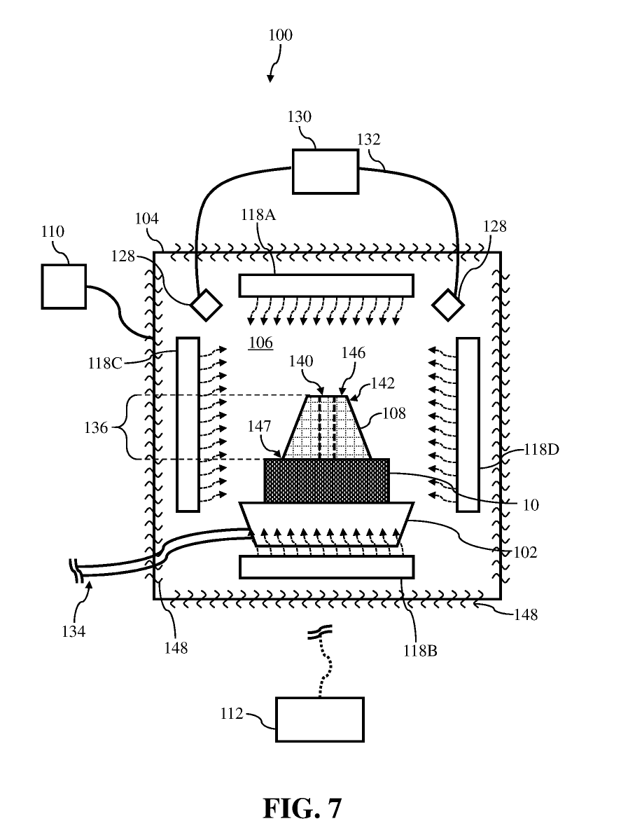

FIG. 7 depicts pre-sintered component 136 undergoing sintering or heating processes. In a non-limiting example, pre-sintered component 136 formed from magnetic powder material 108 may be covered or coated within binder material 146, and heated build chamber 104 may subsequently produce heat 148 to heat or sinter pre-sintered component 136. As discussed herein, controller 112 may activate heat source 110 to provide energy (e.g., electricity) to heated build chamber 104, which in turn allows heated build chamber 104 to generate or produce heat 148 to heat cavity 106 and pre-sintered component 136. In another non-limiting example discussed herein, heated build chamber 104 including pre-sintered component 136 covered or coated within binder material 146 may be placed within or adjacent a larger heating source or component to produce heat 148 and/or heat cavity 106 and pre-sintered component 136. In the non-limiting example shown in FIG. 7, heated build chamber 104 may begin generating heat 148 during a sintering process of pre-sintered component 136 after spray nozzles 128 have covered or coated pre-sintered component 136 with binder material 146 and subsequently shut down or stopped spraying. In another non-limiting example (not shown), heated build chamber 104 may begin to generate heat 148 and/or may begin to heat cavity 106 and pre-sintered component 136, respectively, while spray nozzles 128 continue to cover or coat pre-sintered component 136 with binder material 146.

In the non-limiting example shown in FIG. 7, the plurality of magnets 118 of AMS 100 may remain activated and/or may continue to generate magnetic fields 138 (shown in phantom) when heated build chamber 104 begins to heat pre-sintered component 136. That is, magnetic fields 138 generated by the plurality of magnets 118 may be continually directed toward pre-sintered component 136 formed from magnetic powder material 108 after pre-sintered component 136 is covered or coated in binder material 146 and/or after heated build chamber 104 begins producing heat 148. Although it is discussed herein that binder material 146 covering or coating pre-sintered component 136 maintains the geometry of pre-sintered component 136, the plurality of magnets 118 may continue to generate magnetic fields 138 during at least a portion of the heating or sintering process to ensure or provide a precautionary measure or process and/or ensure pre-sintered component 136 maintains its geometry.

Continuing with the non-limiting example, the plurality of magnets 118 (see, FIGS. 1 and 2) may eventually be deactivated at later time during the heating or sintering process. That is, subsequent to heated build chamber 104 beginning to produce heat 148, but prior to completely sintering or forming the unibody component (see, FIG. 8), controller 112 may deactivate or shut down operations of the plurality of magnets 118 such that the plurality of magnets 118 no longer generate magnetic fields 138. The plurality of magnets 118 may be deactivated or shut down by controller 112 after pre-sintered component 136 formed from magnetic powder material 108 is heated to or beyond its Curie temperature or Curie point. That is, controller 112 may deactivated or shut down the plurality of magnets 118 once pre-sintered component 136 reaches a temperature that magnetic powder material 108 loses its permanent magnetic properties and/or may no longer be manipulated by magnetic fields 138. As discussed herein, binder material 146 covering or coating pre-sintered component 136 maintains the geometry of pre-sintered component 136 while heated build chamber 104 continues to generate heat 148 to heat or sinter pre-sintered component 136.

In another non-limiting example (not shown), the plurality of magnets 118 may continuously generate magnetic fields 138 until magnetic powder material 108 forming pre-sintered component 136 is sintered. Distinct from the example discussed above, controller 112 may maintain operation of the plurality of magnets 118 and/or the generation of magnetic fields 138 through the heating of magnetic powder material 108 to or above a Curie temperature or Curie point. As discussed herein, controller 112 may deactivate or shut down the plurality of magnets 118 only after pre-sintered component 136 has been fully sintered and/or magnetic powder material 108 has been heated to a sintering temperature for a predetermined amount of time to sinter magnetic powder material 108 forming pre-sintered component 136.

In an additional non-limiting example (not shown), the plurality of magnets 118 may be deactivated or shut down by controller 112 after pre-sintered component 136 is covered or coated with binder material 146. Distinct from the examples discussed above, controller 112 may deactivate or shut down the plurality of magnets 118, and stop the generation of magnetic fields 148 by the plurality of magnets 118, subsequent to pre-sintered component 136 being covered or coated with binder material 146. Additionally, in the non-limiting example, controller 112 may deactivate or shut down the plurality of magnets 118 before heated build chamber 104 produces heat 148 to begin to heat or sinter pre-sintered component 136.

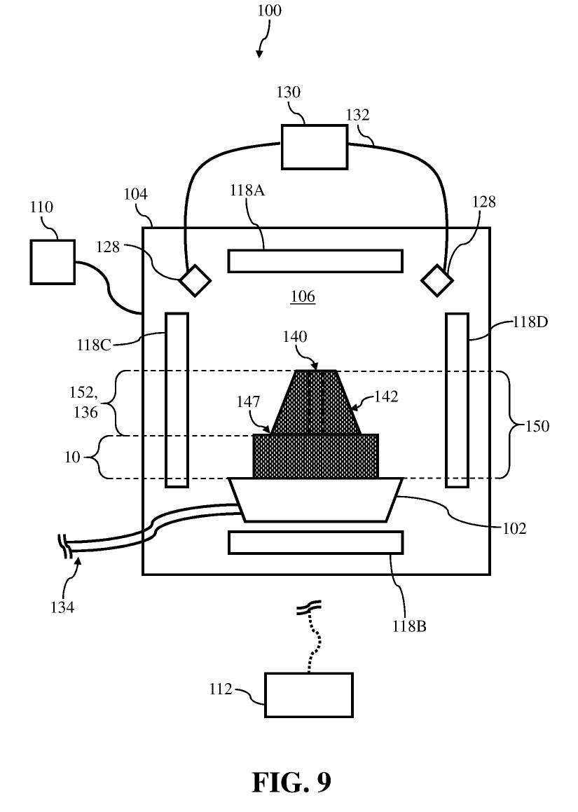

FIGS. 8 and 9 depict a front view of AMS 100 and a unibody component 150 formed by AMS 100 after performing the unibody component formation process discussed herein. Specifically, FIGS. 8 and 9 depict formed unibody component 150 after undergoing a material manipulating process (e.g., FIGS. 3 and 4), a covering or coating process (e.g., FIGS. 5 and 6) and a heating or sintering process (e.g., FIG. 7) performed by AMS 100 and its various components (e.g., build platform 102, heated build chamber 104, magnets 118, and so on). As discussed herein, unibody component 150 may refer to a single, continuous or unseparated component formed from magnetic powder material 108 and preformed component 10.

As shown in FIGS. 8 and 9, and with comparison to FIG. 3, magnetic powder material 108 forming pre-sintered component 136 has been sintered to form a sintered portion 152 of unibody component 150. Collectively, sintered portion 152 formed from pre-sintered component 136 and preformed component 10 may form unibody component 150. In the non-limiting example shown in FIG. 8, magnetic powder material 108 forming pre-sintered component 136 may be sintered to form sintered portion 152 of unibody component 150, where sintered portion 152 and preformed component 10 may become integral, fused, integrated, amalgamated and/or merged. In this non-limiting example, magnetic powder material 108 may fuse and/or be transferred into a portion of the material forming preformed component 10, and vice versa. As a result, interface 147 (see, FIGS. 5 and 6) between sintered portion 152 and preformed component 10 may disappear and/or the material or component transition between sintered portion 152 and preformed component 10 may no longer exist in unibody component 150. In the non-limiting example shown in FIG. 9, sintered portion 152 formed from pre-sintered component 136 may be sintered to form a portion of unibody component 150, where sintered portion 152 and preformed component 10 may become joined, permanently coupled, and/or affixed at interface 147. That is, and as discussed herein, although interface 147 may still exist, sintered portion 152 and preformed component 10 may be joined when sintering pre-sintered component 136 (see, FIGS. 3 and 6) to form a single, continuous component (e.g., unibody component 150) from magnetic powder material 108 and preformed component 10.

The physical, chemical, material and/or mechanical properties (e.g., strength) of sinter portion 152 of unibody component 150 may be distinct and/or altered from those properties of magnetic powder material 108 forming pre-sintered component 136 (see. FIG. 3). Specifically, sintering pre-sintered component 136 formed from magnetic powder material 108 may substantially alter or change the physical, chemical, material and/or mechanical properties of sinter portion 152 of unibody component 150 to meet required specification for use of unibody component 150 within a system. The changed or altered physical, chemical, material and/or mechanical properties of sinter portion 152 may be substantially distinct from or similar to physical, chemical, material and/or mechanical properties of preformed component 10. The relationship and/or correspondence between the physical, chemical, material and/or mechanical properties of sinter portion 152 and preformed component 10 forming unibody component 150 may be dependent on, at least in part, the material composition of magnetic powder material 108 and/or preformed component 10. In a non-limiting example, when magnetic powder material 108 is sintered it may include physical, chemical, material and/or mechanical properties substantially similar to that of the material forming preformed component 10. As a result, during sintering the materials for each of sintered portion 152 and preformed component 10 may fuse and/or be transferred to form unibody component 150 (see, FIG. 8).

Although the properties (e.g., strength) of sintered portion 152 may be distinct or different from magnetic powder material 108 forming pre-sintered component 136, the geometry of sintered portion 152 of unibody component 150 may be the same or substantially identical to pre-sintered component 136. That is, sintered portion 152 may include a geometry that is substantially the same or substantially identical to the geometry of pre-sintered component 136. For example, sintered portion 152 may include aperture 140 and angular sidewalls 142. Once formed, unibody component 150 formed from sintered portion 152 and preformed component 10 may be removed from heated build chamber 104 of AMS 100 and may undergo final component processing (e.g., polishing, buffing, grinding) and/or may be implemented within a system or machine that utilizes unibody component 150 during operation. In a non-limiting example, sintered component 150 may undergo a heat-treating process to remove (e.g., burn out) at least a portion of binder material 146 that may fuse and/or be formed within the sintered component 150 as a result of the covering/coating and/or sintering processes, as discussed herein.

FIGS. 10-12 depict further non-limiting examples of AMS 100. Specifically, FIGS. 10-12 each depict distinct, non-limiting examples for the configuration of the preformed component and the pre-sintered component within AMS 100. It is understood that similarly numbered and/or named components may function in a substantially similar fashion. Redundant explanation of these components has been omitted for clarity.

As shown in FIG. 10, and distinct from the examples discussed above, preformed component 10 may be formed as a distinct pre-sintered component 236B. That is, unibody component 150 (see, FIG. 8 or 9) may be formed from pre-sintered component 236A formed or positioned on preformed component 10 formed as distinct pre-sintered component 236B. In the non-limiting example show in FIG. 10, pre-sintered component 236A and preformed component 10 formed as distinct pre-sintered component 236B may be depicted as undergoing a heating or sintering process as discussed herein with respect to FIG. 7. In a non-limiting example, distinct pre-sintered component 236B may be formed (e.g., manipulated and coated) prior to the formation of pre-sintered component 236A. That is, distinct pre-sintered component 236B may be formed in a substantially similar manner using AMS 100 by performing a material manipulating process (e.g., FIGS. 3 and 4), and a spraying, covering or coating process (e.g., FIGS. 5 and 6) using AMS 100. In the non-limiting example, once distinct pre-sintered component 236B is formed, magnetic powder material 108 may be deposited on distinct pre-sintered component 236B and may undergo similar processes discussed herein to form pre-sintered component 236A (sprayed with binder material 146) directly on distinct pre-sintered component 236B. In another non-limiting example, at least a portion of the plurality of magnets 118 (see, FIG. 1) may manipulate magnetic powder material 108 to form distinct pre-sintered component 236B. Next, additional magnetic powder material 108 may be deposited onto distinct pre-sintered component 236B, and magnets 118 may manipulate that magnetic powder material 108 to form pre-sintered component 236A. Once both pre-sintered component 236A and distinct pre-sintered component 236B are formed, spray nozzles 128 may simultaneously cover both pre-sintered component 236A and distinct pre-sintered component 236B within binder material 146 (see, FIGS. 5 and 6) as discussed herein. Once pre-sintered component 236A and distinct pre-sintered component 236B are formed, heating build chamber 104 may be heated and/or generate heat 148 to sinter both pre-sintered component 236A and distinct pre-sintered component 236B simultaneously to form unibody component 150, as discussed herein.

In the non-limiting example shown in FIG. 11, and with comparison to FIG. 6, the order and/or position of pre-sintered component 336 and preformed component 10 may be switched or reversed. Specifically, pre-sintered component 336 formed from magnetic powder material 108 may be positioned directly on build platform 102, and preformed component 10 may be positioned directly on pre-sintered component 336, adjacent build platform 102. In the non-limiting example shown in FIG. 11, pre-sintered component 336 may be formed prior to positioning preformed component 10 on pre-sintered component 336. That is, magnetic powder material 108 may initially be positioned directly on build platform 102, and may be manipulated using magnets 118 (see, FIG. 1) to form pre-sintered component 336, as discussed herein. Pre-sintered component 336 positioned directly on build platform 102 may then be sprayed, covered or coated within binder material 146 prior to or after preformed component 10 is positioned directly on pre-sintered component 336. Once covered with binder material 146, heated build chamber 104 may heat or sinter pre-sintered component 336 to form unibody component 150, as similarly discussed herein with respect to FIGS. 7-9. As shown in the non-limiting example of FIG. 11, preformed component 10 may include similar features (e.g., aperture 40, angular sidewalls 42) as those discussed herein with respect to pre-sintered component 136 depicted in FIG. 3.

In a non-limiting example shown in FIG. 12, both magnetic powder material 108 and preformed component 10 may at least initially be positioned on build platform 102. That is, magnetic powder material 108 and preformed component 10 may be positioned on build platform 102, adjacent one another. Magnetic powder material 108 may then be manipulated using magnets 118 (see, FIG. 1), as discussed herein, to form pre-sintered component 436 on a side of preformed component 10. As a result, pre-sintered component 436 may be positioned on preformed component 10, and may also be positioned adjacent to both preformed component 10 and build platform 102. Once pre-sintered component 436 is formed, AMS 100 may perform the various processes discussed herein (e.g., spraying with binder material 146, heating or sintering using heated build chamber 104) to form unibody component 150 from pre-sintered component 436 and preformed component 10.

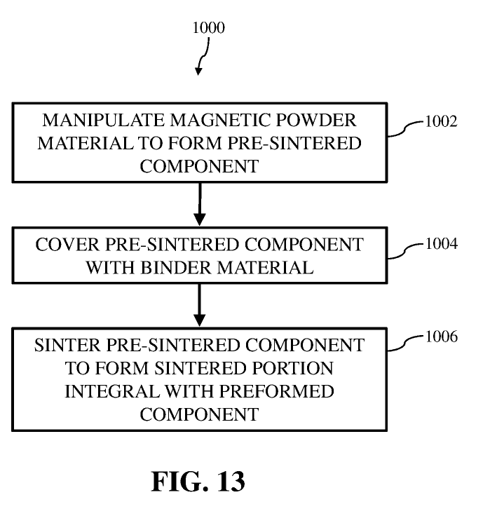

FIG. 13 shows an example process for forming a unibody component using an additive manufacturing system (hereafter, “AMS”). Specifically, FIG. 13 is a flowchart depicting one example process 1000 for forming a unibody component from a pre-sintered component and a preformed component. In some cases, the process may be used to form unibody component 150, as discussed herein with respect to FIGS. 1-12.

In operation 1002, a magnetic powder material may be manipulated. The magnetic powder material may be manipulated using magnetic waves to form a pre-sintered component having a first geometry. Manipulating the magnetic powder to form the pre-sintered component may include adjusting operational characteristic(s) of at least one magnet of the AMS that may substantially surround and/or be positioned adjacent the magnetic powder material. Adjusting the operational characteristic(s) of the magnet(s) of the AMS may include, but is not limited to, activating at least one magnet(s), modifying a magnetic polarity of at least one of the magnets, modifying a magnetic field strength of at least one of the magnets, changing a distance between at least one magnet and the magnetic powder material, and/or changing a position of the at least one magnet of the AMS.

In operation 1004, the pre-sintered component formed from the magnetic powder material may be covered or coated with a binder material. The pre-sintered component may be covered or coated with a liquid binder material, a vapor binder material or any other suitable binder, adhesive and/or curable material that may maintain the geometry of the pre-sintered component 136 after covering or coating. In a non-limiting example, covering or coating the pre-sintered component with the binder material may include spraying the binder material directly on the pre-sintered component. In another non-limiting example covering or coating the pre-sintered component with the binder material may include dispensing into or flooding a cavity containing the pre-sintered component to coat or cloak the pre-sintered material with the binder material. Covering the pre-sintered component may also include covering an interface between the pre-sintered component formed from the magnetic powder material and a preformed component contacting the pre-sintered component.

In operation 1006, the pre-sintered component may be sintered to form a sintered portion integral with the preformed component contacting the pre-sintered component. Sintering the pre-sintered component to form the sintered portion may form the unibody component out of sintered portion and the preformed component. Sintering the pre-sintered component may include heating the pre-sintered component and the preformed component using a heated build chamber surrounding the pre-sintered component and preformed component, respectively. The pre-sintered component may be heated until the magnetic powder material forming the pre-sintered component is heated to its sintering temperature to form the unibody component. Additionally, sintering the pre-sintered component may include joining the sintered portion directly to the preformed component contacting the pre-sintered component. Furthermore, where the preformed component is formed from a distinct pre-sintered component, sintering pre-sintered component may also include sintering the preformed component formed as the distinct pre-sintered component. The unibody component formed by sintering or heating the pre-sintered component may include a second geometry, which is substantially the same or substantially identical to the first geometry of the pre-sintered component.

Although shown in FIG. 13 as being performed linearly or in succession of one another, it is understood that at least some of the operations of process 1000 may be performed in distinct order than that shown, and/or may two or more operations may be formed simultaneously. For example, heating the pre-sintered component to sinter in operation 1006 may begin prior to, or at the same time as the pre-sintered component being covered with the binder material in operation 1004.

Furthermore, process 1000 may include additional operations that may be performed before and/or after the operations shown and discussed with respect to FIG. 13. These additional operations may depend on the position of the pre-sintered component and/or the preformed component within the AMS used to form the unibody component. In a non-limiting example where the preformed component is positioned directly on a build platform of the AMS, additional operations may be performed prior to manipulating the magnetic powder material. Specifically, the preformed component may be positioned directly on the build platform of the AMS and then the magnetic powder material may be positioned directly on or adjacent the preformed component, prior to manipulating the magnetic powder material, as discussed with respect to operation 1002. Where the magnetic powder material is positioned adjacent to the preformed component, the magnetic powder material may also be positioned directly on the build platform of the AMS.

In another non-limiting example where the pre-sintered component is positioned directly on a build platform of the AMS, additional operations may be performed prior to performing the sintering operation in 1006. Specifically, the pre-sintered component may be positioned directly on the build platform of the AMS and then may undergo the material manipulating in operation 1002. Prior to, or subsequent to performing the covering of the pre-sintered component in operation 1004, the preformed component may be positioned directly on or adjacent the pre-sintered component.

As discussed herein, controller 112 of AMS 100 may be implemented as or on a computer device or system (hereafter “computer”). Controller 112, as described herein, executes code that includes a set of computer-executable instructions defining unibody component 150 (see, e.g., FIG. 6) to first manipulate magnetic powder material 108 to form pre-sintered component 136 having the same geometry of unibody component 150, and subsequently have heated build chamber 104 sinter pre-sintered component 136 to form unibody component 150, as discussed herein. Controller 112, or the computer including controller 112, may include a memory, a processor, an input/output (I/O) interface, and a bus. Further, the computer may be configured to communicate with an external I/O device/resource and a storage system. In general, the processor executes computer program code that is stored in the memory and/or the storage system under instructions from the code representative of unibody component 150, described herein. While executing computer program code, the processor can read and/or write data to/from the memory, the storage system, and/or the I/O device. A bus provides a communication link between each of the components in controller 112 or the computer including controller 112, and the I/O device can comprise any device that enables a user to interact with controller 112 and/or the computer (e.g., keyboard, pointing device, display, etc.).

Controller 112 or the computer including controller 112 are only representative of various possible combinations of hardware and software. For example, the processor may comprise a single processing unit, or be distributed across one or more processing units in one or more locations, e.g., on a client and server. Similarly, the memory and/or the storage system may reside at one or more physical locations. The memory and/or the storage system can comprise any combination of various types of non-transitory computer readable storage medium including magnetic media, optical media, random access memory (RAM), read only memory (ROM), etc. Controller 112 or the computer including controller 112 can comprise any type of computing device such as a network server, a desktop computer, a laptop, a handheld device, a mobile phone, a pager, a personal data assistant, etc.

Additionally, and as discussed herein, the process of forming unibody component 150 may begin with a non-transitory computer readable storage medium (e.g., memory, storage system, etc.) storing code representative of unibody component 150. As noted, the code includes a set of computer-executable instructions defining unibody component 150 that can be used to physically generate the object, upon execution of the code by controller 112 or the computer including controller 112. For example, the code may include a precisely defined 3D model of unibody component 150 and can be generated from any of a large variety of well-known computer aided design (CAD) software systems such as AutoCAD®, TurboCAD®, DesignCAD 3D Max, etc. In this regard, the code can take any now known or later developed file format. Controller 112 or the computer including controller 112 executes the code, which in turn instructs AMS 100 and its various components to form unibody component 150 using the processes discussed herein.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system comprising:
a build platform configured to receive:
a preformed component; and
a magnetic powder material;
at least one magnet positioned adjacent the build platform, the at least one magnet configured to manipulate the magnetic powder material to form a pre-sintered component in contact with the preformed component;
at least one sprayer nozzle positioned adjacent the build platform, the at least one sprayer nozzle configured to coat the pre-sintered component formed from the magnetic powder material with a binder material; and
a heated build chamber substantially surrounding the build platform, the heated build chamber configured to heat the pre-sintered component to form a sintered portion integral with the preformed component.

2. The system of claim 1, wherein at least one of the preformed component or the magnetic powder material is positioned directly on the build platform.

3. The system of claim 2, wherein the preformed component is positioned directly on the build platform and the pre-sintered component formed from the magnetic powder material is positioned directly on the preformed component.

4. The system of claim 2, wherein the pre-sintered component formed from the magnetic powder material is positioned directly on the build platform and the preformed component is positioned directly on the pre-sintered component.

5. The system of claim 1, wherein the preformed component includes one of:
a metal component, or
a distinct pre-sintered component covered in the binder material.

6. The system of claim 1, wherein the pre-sintered component includes a first geometry identical to a second geometry of the sintered portion.

7. A method of forming a unibody component comprising:
manipulating a magnetic powder material, using magnetic waves, to form a pre-sintered component having a first geometry, the magnetic powder material positioned adjacent a build platform;
covering the pre-sintered component formed from the magnetic powder material with a binder material; and
sintering the pre-sintered component formed from the magnetic powder material to form a sintered portion integral with a preformed component, the sintered portion having a second geometry identical to the first geometry of the pre-sintered component.

8. The method of claim 7, further comprising:
prior to manipulating the magnetic powder material, positioning the preformed component directly on the build platform; and
positioning the magnetic powder material on or adjacent the preformed component.

9. The method of claim 8, wherein positioning the magnetic powder material adjacent the preformed component further comprises:
positioning the magnetic powder material directly on the build platform.

10. The method of claim 8, wherein covering the pre-sintered component further comprises:
covering an interface between the pre-sintered component formed from the magnetic powder material and the preformed component with the binder material.

11. The method of claim 7, wherein sintering the pre-sintered component formed from the magnetic powder material further comprises:
heating the pre-sintered component formed from the magnetic powder and the preformed component using a heated build chamber.

12. The method of claim 7, further comprising:
prior to manipulating the magnetic powder material, positioning the magnetic powder material directly on the build platform.

13. The method of claim 11, further comprising:
positioning the preformed component on or adjacent the pre-sintered component covered in the binder material prior or subsequent to covering the pre-sintered component with the binder material.

14. The method of claim 7, further comprising:
forming the preformed component from a distinct pre-sintered component covered in the binder material.

15. The method of claim 14, wherein sintering the pre-sintered component formed from the magnetic powder material further comprises:
sintering the distinct pre-sintered component covered in the binder material forming the preformed component.

16. The method of claim 7, wherein sintering the pre-sintered component formed from the magnetic powder material further comprises:
joining the sintered portion directly to the preformed component.
